(19) United States
(12) Patent Application Publication
(10) Pub. No.: US 2010/0208025 A1
(43) Pub. Date: Aug. 19, 2010

(54) EXPOSURE DEVICE, IMAGE FORMING APPARATUS AND COMPUTER-READABLE MEDIUM

(75) Inventors: Atsushi UGAJIN, Kanagawa (JP); Satoshi KURASHIMA, Kanagawa (JP); Kohei SHIOYA, Kanagawa (JP); Tetsuya HORI, Kanagawa (JP); Tomoaki SAKITA, Kanagawa (JP)

Correspondence Address: SUGHRUE-265550, 2100 PENNSYLVANIA AVE. NW, WASHINGTON, DC, 20037-3213, US

(73) Assignee: FUJI XEROX CO., LTD., Tokyo (JP)

(21) Appl. No.: 12/569,933

(22) Filed: Sep. 30, 2009

(30) Foreign Application Priority Data
Feb. 13, 2009 (JP) 2009-030591

(51) Int. Cl. B41J 2/435

(52) U.S. Cl. 347/224

(57) ABSTRACT

An exposure device includes a reference current generating unit generating a reference current for each image of respective colors, a photoelectric current generating unit generating a photoelectric current in response to a light amount of the light emitting element, a driving unit driving the light emitting element, a first controller, a drive voltage holding unit holding a drive voltage given to the driving unit, a second controller controlling the driving unit based on the drive voltage held, a comparison current generating unit generates a comparison current, a difference current generating unit generating a difference current, of each color, corresponding to a difference between the reference current of each color and the comparison current. The first controller compares a value obtained by adding the difference current of each color to the photoelectric current with the comparison current to control the driving unit so that the photoelectric current becomes the reference current.

### CROSS-REFERENCE TO RELATED APPLICATIONS

This application is based on and claims priority under 35 USC 119 from Japanese Patent Application No. 2009-30591 filed Feb. 13, 2009.

### BACKGROUND

### Technical Field

The present invention relates to an exposure device, an image forming apparatus and a computer-readable medium storing a program that causes a computer to execute an exposure control process.

### SUMMARY

According to an aspect of the invention, an exposure device includes a light emitting element, a reference current generating unit, a photoelectric current generating unit, a driving unit, a first controller, a drive voltage holding unit, a second controller, a comparison current generating unit and a difference current generating unit. The reference current generating unit generates a reference current which gives a target value of a light amount of the light emitting element, for each image of respective colors formed by exposure using the light emitting element. The photoelectric current generating unit generates a photoelectric current in response to the light amount of the light emitting element. The driving unit drives the light emitting element. The first controller controls the driving unit so that the photoelectric current becomes equal to the reference current. The drive voltage holding unit holds a drive voltage which is given to the driving unit by the first controller. The second controller controls the driving unit based on the drive voltage held by the drive voltage holding unit to carry out the exposure by the light emission of the light emitting element. The comparison current generating unit generates a certain comparison current. The difference current generating unit generates a difference current, of each color, having a value corresponding to a difference between the reference current of each color and the comparison current. The first controller compares a value obtained by adding the difference current of each color to the photoelectric current with the comparison current to control the driving unit so that the photoelectric current becomes equal to the reference current.

### BRIEF DESCRIPTION OF THE DRAWINGS

Exemplary embodiments of the invention will be described below in detail based on the accompanying drawings, wherein:

FIG. 1 is a schematic view showing the entire configuration of an image forming apparatus according to one exemplary embodiment of the present invention;

FIG. 2 is a view for explaining the configuration of an optical system of an optical beam scanning device in the image forming apparatus according to the one exemplary embodiment of the present invention;

FIG. 3 is a view for explaining the configuration of the optical system of the optical beam scanning device in the image forming apparatus according to the one exemplary embodiment of the present invention;

FIG. 4 is a circuit diagram showing the entire configuration of a light emitting element drive unit in the image forming apparatus according to the one exemplary embodiment of the present invention;

FIG. 5 is a circuit diagram showing the entire configuration of the light emitting element drive unit in the image forming apparatus according to the one exemplary embodiment of the present invention;

FIG. 6 is a block diagram showing electrical connections of a control section for controlling a YM image forming unit and a CK image forming unit in the image forming apparatus according to the one exemplary embodiment of the present invention;

FIG. 7 is a flowchart when an APC operation is carried out in the image forming apparatus according to the one exemplary embodiment of the present invention;

FIG. 8 is a graph for explaining an operation of the light emitting element drive unit in the image forming apparatus according to the one exemplary embodiment of the present invention;

FIG. 9 is a flowchart when the APC operation is carried out in the image forming apparatus according to the one exemplary embodiment of the present invention; and

FIG. 10 is a flowchart when the APC operation is not carried out in the image forming apparatus according to the one exemplary embodiment of the present invention.

### DETAILED DESCRIPTION

Hereinafter, exemplary embodiments of the present invention will be described.

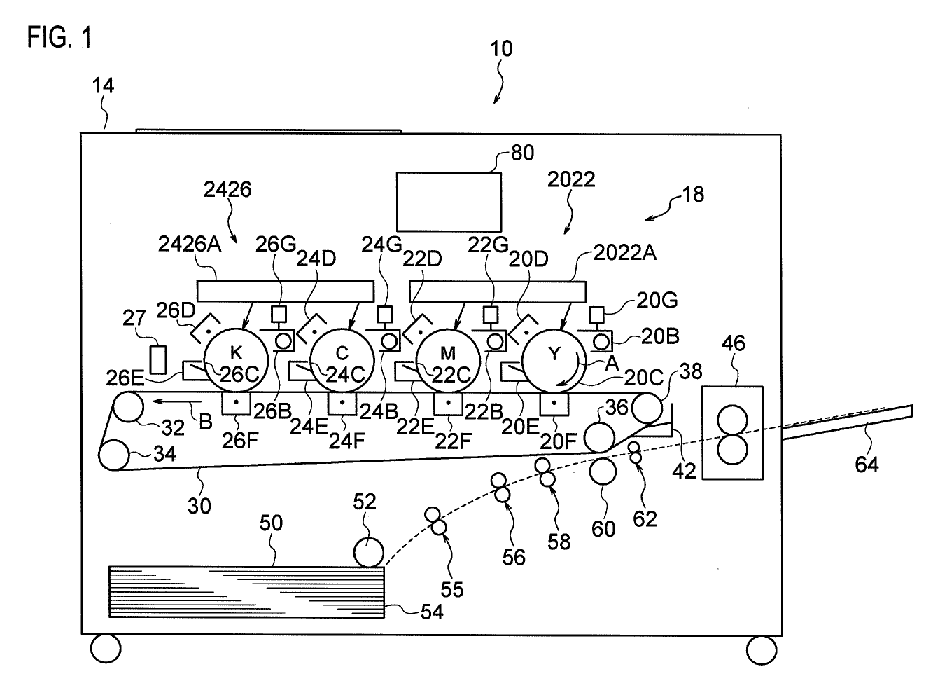

FIG. 1 is a schematic view showing the entire configuration of an image forming apparatus 10 according to this exemplary embodiment.

The image forming apparatus 10 is covered by a casing 14. The image forming apparatus 10 includes an image forming section 18 and an image processing control section 80 in the interior of the casing 14. The image forming section 18 forms color images on sheets. The image processing control section 80 controls the entirety of image processing in the image forming section 18.

The image forming section 18 includes an intermediate transfer body 30, a YM image forming unit 2022, a CK image forming unit 2426, a sheet conveyance path, conveyance rollers and a fixing device 46. The intermediate transfer body 30 serves as a recording medium that conveys, in a conveyance direction indicated by an arrow B in FIG. 1, a developing material which forms an image and which electrostatically absorbs thereto. The intermediate transfer body 30 is a belt structure which travels around with being wound on rollers 32, 34, 36 and 38. The YM image forming unit 2022 forms a Y (yellow) color image and a M (magenta) color image. The CK image forming unit 2426 forms a C (cyan) color image and a K (black) color image. The YM image forming unit 2022 and the CK image forming unit 2426 are disposed in a tandem manner from the upstream side toward the downstream side along a conveyance direction (the direction of the arrow B shown in FIG. 1) of the intermediate transfer body 30. The sheet conveyance path and conveyance rollers are configured to feed out a sheet 50 from a sheet accommodation section 54 and to convey the same. The fixing device 46 performs a fixing process for the sheet onto which a toner image is transferred. Also, the image forming section 18 includes a detection section 27, serving as position detecting unit, on the downstream side of the CK image forming unit 2426 in the conveyance direction (the direction of the arrow B in FIG. 1).

The YM image forming unit 2022 is provided with an optical beam scanning device 2022A that is an exposure device common to Y and M colors. The optical beam scanning device 2022A emits Y-color laser light and M-color laser light which are modulated based on image data.

For the Y color, the YM image forming unit 2022 includes a photosensitive drum 20C, a charging device 20D, a developing device 20B, a toner feeding part 20G, a transfer device 20F and a cleaning device 20E. The charging device 20D charges the photosensitive drum 20C at a predetermined potential. The developing device 20B develops a latent image formed by Y-color laser light output from the optical beam scanning device 2022A. The toner feeding part 20G feeds a Y-color toner to the developing device 20B. The transfer device 20F transfers a yellow toner image from the photosensitive drum 20C onto the intermediate transfer body 30. The cleaning device 20E removes toner from the outer circumferential surface of the photosensitive drum 20C.

For the M color, the YM image forming unit 2022 includes a photosensitive drum 22C, a charging device 22D, a developing device 22B, a toner feeding part 22G, a transfer device 22F and a cleaning device 22E.

The CK image forming unit 2426 includes an optical beam scanning device 2426A serving as an exposure device common to C and K colors. The optical beam scanning device 2426A emits C-color laser light and K-color laser light, which are modulated based on image data.

For the C color, the CK image forming unit 2426 includes a photosensitive drum 24C, a charging device 24D, a developing device 24B, a toner feeding part 24G, a transfer device 24F and a cleaning device 24E. The charging device 24D charges the photosensitive drum 24C at a predetermined potential. The developing device 24B develops a latent image formed by C-color laser light output by an optical beam scanning device 2426A. The toner feeding part 24G feeds a C-color toner to the developing device 24B. The transfer device 24F transfers a C-color toner image from the photosensitive drum 24C onto the intermediate transfer body 30. The cleaning device 24E removes toner from the outer circumferential surface of the photosensitive drum 24C.

For the K color, the CK image forming unit 2426 includes a photosensitive drum 26C, a charging device 26D, a developing device 26B, a toner feeding part 26G, a transfer device 26F and a cleaning device 26E.

Scanning exposure of optical beams from the optical beam scanning device 2022A and the optical beam scanning device 2426A to the photosensitive drum 20C, the photosensitive drum 22C, the photosensitive drum 24C and the photosensitive drum 26C is carried out at predetermined intervals that are determined by a conveyance speed of the intermediate transfer body 30 and distances between the photosensitive drum 20C, the photosensitive drum 22C, the photosensitive drum 24C, and the photosensitive drum 26C.

As shown in FIG. 1, a sheet accommodation section 54 that accommodates sheets 50 is provided below the intermediate transfer body 30. An uppermost sheet 50 of the sheet accommodation section 54 is fed out to a sheet conveyance path by means of a feed-out roller 52. A fed-out sheet 50 is conveyed through the sheet conveyance path by the conveyance roller 55, a conveyance roller 56 and a conveyance roller 58, and reaches the vicinity of the intermediate transfer body 30.

A conveyance roller 60 that faces the conveyance roller 36 across the intermediate transfer body 30 is provided on the sheet conveyance path. A color image that is formed by superimposing toner images of the respective colors on the intermediate transfer body 30 is transferred onto the sheet 50 when the sheet 50 is conveyed through the facing part between the conveyance roller 36 (in fact, the intermediate transfer body 30) and conveyance roller 60.

The sheet 50 having the color image transferred thereon is conveyed to the fixing device 46 by a conveyance roller 62. After the sheet 50 is subjected to the fixing process (heated and pressurized) by the fixing device 46, the sheet 50 is ejected to a sheet tray 64.

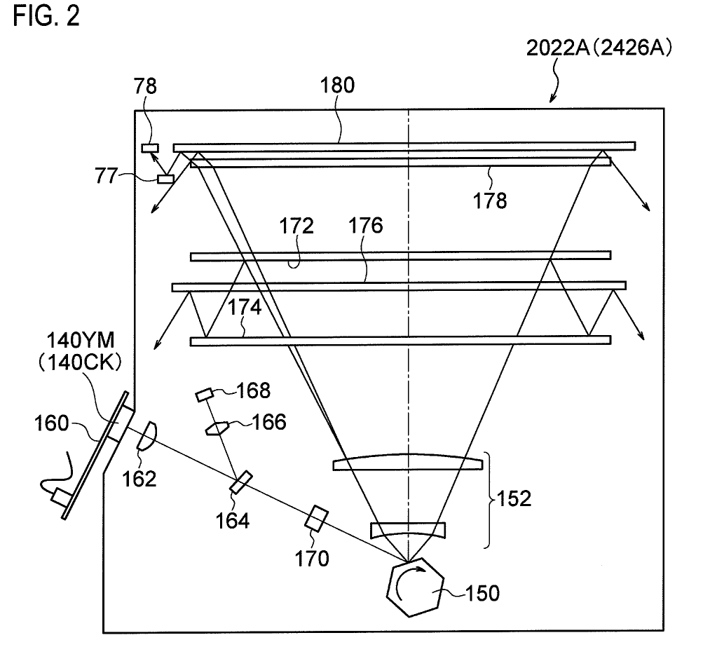

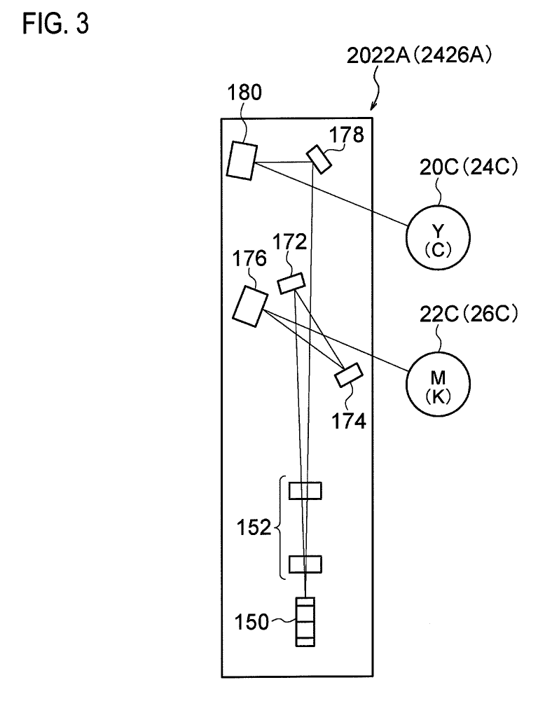

FIG. 2 and FIG. 3 are views for explaining the configuration of an optical system of the optical beam scanning device 2022A.

The optical beam scanning device 2022A (the optical beam scanning device 2426A has a similar structure) has an optical system that causes plural optical beams simultaneously to be incident into a single rotary polygon mirror unit 150 and guides the optical beams, which have passed through an fθ lens 152, to the photosensitive drum 20C for Y color and the photosensitive drum 22C for M color (or the photosensitive drum 24C for C color and the photosensitive drum 26C for K color) which are shown in FIG. 3.

The rotary polygon mirror unit 150 is an assembly composed of a polygon mirror having planar mirror surfaces on its circumference and a motor coupled with the rotation axis of the polygon mirror to rotate the polygon mirror at a high speed.

The optical beam scanning device 2022A of FIG. 2 corresponds to image data of yellow (Y) and magenta (M) colors. Also, the optical beam scanning device 2426A corresponds to image data of cyan (C) and black (K) colors.

A light source (laser light-emitting arrays) 140YM (140CK) attached to a circuit substrate 160A has plural (e.g., thirty two) light emitting elements (details of which will be described later). As shown in FIG. 2, optical beams are emitted from the plural light emitting elements of the light source 140YM (140CK), pass through a collimator lens 162 and are separated into reflection light and transmission light by a half mirror 164.

The reflection light is input into a photo detector 168 via a lens 166, and is adjusted to a predetermined light amount in a light amount control (APC: Auto Power Control) which will be described in detail later.

Also, the transmission light, which passes through the half mirror 164, is incident into the rotary polygon mirror unit 150 via a cylindrical lens 170, and reflection light thereof (scanning light) passes through the f0 lens 152.

Here, a part of the optical beam passing through the fθ lens 152 is incident into a cylindrical mirror for M (the cylindrical mirror for K) 176 via reflection mirrors 172 and 174, and is guided to the photosensitive drum 22C (1026C).

Also, another part of the optical beam passing through the fθ lens 152 is incident into a cylindrical mirror for Y (the cylindrical mirror for C) 1180 via a reflection mirror 178, and is guided to the photosensitive drum 20C (24C).

At this time, the optical system is configured so that an optical beam of any one of the colors is incident into an SOS (Start of Scan) sensor 78 via a reflection mirror 77.

The laser light-emitting arrays 140YM and 140CK (hereinafter, which may be collectively referred to as a “laser light-emitting array 140”) are configured so that light emitting elements 2 serving as laser light sources are arranged in an array manner with plural light emitting elements being disposed in a main-scanning direction and with plural light emitting elements being disposed in a sub-scanning direction. The light emitting elements 2 are vertical cavity surface emitting laser diodes for forming latent images on the surfaces of the photosensitive drums 20C, 22C, 24C, 26C (hereinafter which may be referred to as a “photosensitive drum 20C” representing the respective photosensitive drums).

Hereinafter, a control system for controlling amounts of light emitted from the light emitting elements will be described in detail.

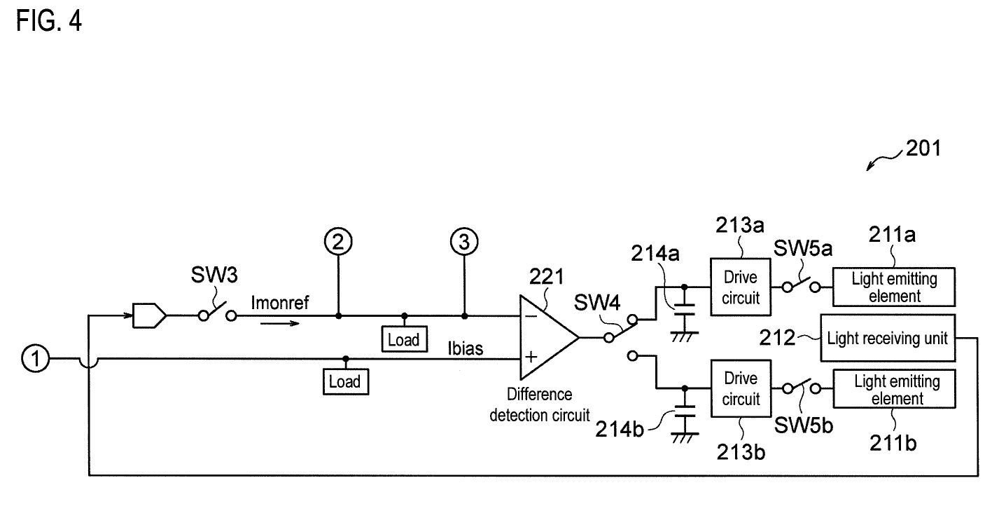

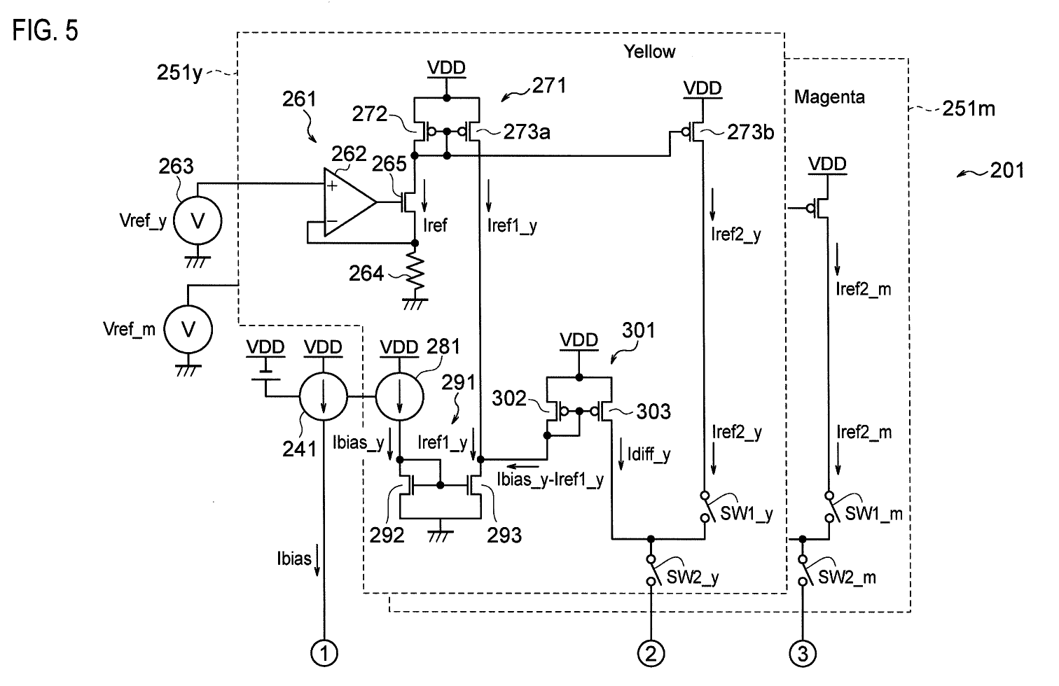

FIG. 4 and FIG. 5 are circuit diagrams showing the entire configuration of a light emitting element drive unit 201 that controls the amounts of light emitted from the light emitting elements.

The light emitting element drive unit 201 is shown as a light emitting element drive unit 201 that is provided in the optical beam scanning unit 2022A, which is the exposure device common to Y color and M color of the YM image forming unit 2022. A light emitting element drive unit 201 of the optical beam scanning unit 2426A serving as an exposure device common to C color and K color of the CK image forming unit 2426 also has a similar circuit configuration thereto. Therefore, description will be given on the light emitting element drive unit 201 of the optical beam scanning unit 2022A as a representative.

For the sake of simplicity, this example shows the case in which two light emitting elements 211a and 211b are driven and controlled. However, the configuration is not limited to the above-described example in which two light emitting elements 211a and 211b are driven. It is a matter of course that such a configuration in which a single light emitting element or three or more light emitting elements are driven may be adopted. This example shows the configuration of the circuit system of the light amount controlling circuit for carrying out the feedback control for the amounts of light emitted from the light emitting elements 211a and 211b to be a target light amount.

A light receiving unit 212 (e.g., the photo detector 168) is formed of, for example, a photodiode. The light receiving unit 212 receives optical beams emitted from the light emitting elements 211a and 211b, and outputs a photoelectric current in response to the amount of received light.

A difference detection circuit 221 is formed of, for example, an operational amplifier. The light receiving unit 212 outputs the photoelectric current Imonref to an inverting (−) input terminal of the difference detection circuit 221. A predetermined voltage is supplied into a non-inverting (+) input terminal of the difference detection circuit 221. The difference detection circuit 221 supplies a voltage in accordance with a difference between the photoelectric current Imonref and the predetermined voltage.

A drive circuit 213a drives the light emitting element 211a, and a drive circuit 213b drives the light emitting element 211b. The output of the difference detection circuit 221 is selectively given to either the drive circuit 213a or 213b by changing a switch SW4.

One end of a sample-hold circuit 214a is connected to a line connecting the output terminal of the difference detection circuit 221 to the drive circuit 213a, and the other end of the sample-hold circuit 214a is connected to the ground GND. The sample-hold circuit 214a samples and holds a value of a voltage given from the difference detection circuit 221 to the drive circuit 213a. One end of a sample-hold circuit 214b is connected to a line connecting the output terminal of the difference detection circuit 221 to the drive circuit 213b, and the other end of the sample-hold circuit 214b is connected to the ground GND. The sample-hold circuit 214b samples and holds the value of the voltage given from the difference detection circuit 221 to the drive circuit 213b as a sample.

In such a circuit configuration, the difference detection circuit 221 carries out the feedback control for the light amounts of the light emitting elements 211a and 211b, which are received by the light receiving unit 212, to be a target light amount. That is, if a reference current corresponding to the target light amount is given to the non-inverting (+) input terminal of the difference detection circuit 221, the light emitting elements 211a and 211b can be controlled so as to be the light amount corresponding to the reference current.

In order to expose the photosensitive drum 20C (hereinafter, a representative of the photosensitive drums of the respective colors Y, M, C and K may be referred to as the “photosensitive drum 20C”) with light emitted from the light emitting elements 211a and 211b, an operation referred to as the “Auto Power Control” (APC) is carried out so that errors in the light emitting elements 211a and 211b don't cause unevenness in colors.

That is, the reference current corresponding to the target light amount is given to the non-inverting (+) input terminal of the difference detection circuit 221, and the sample-hold circuit 214a or 214b is caused to sample and hold the output voltage of the difference detection circuit 221 when the output of the difference detection circuit 221 becomes stable. When the light emitting elements 211a and 211b are caused to emit light in order to expose the photosensitive drum 20C, the drive circuits 213a and 213b cause the light emitting elements 211a and 211b to emit light using the voltages, which are sampled and held in the sample-hold circuit 214a or 214b, as the drive voltages. Therefore, the light emitting elements 211a and 211b are caused to emit light with the light amounts of the light emitting elements 211a and 211b being controlled to the target light amount.

In this exemplary embodiment, the optical beam scanning unit 2022A of the YM image forming unit 2022 serves as the exposure device common to Y color and M color. The above-described feedback control system having the difference detection circuit 221 and the light receiving unit 212, etc., uses a common circuit. That is, the above-described feedback control system is commonly used in formation of a Y-color latent image and formation of a M-color latent image.

Here, optical energies given to the photosensitive drums vary depending upon the colors Y, M, C and K. Therefore, in the optical beam scanning unit 2022A, the values of the reference voltages given to the non-inverting (+) input terminal of the difference detection circuit 221 vary from the case where a Y-color latent image is formed to the case where an M-color latent image is formed. Therefore, the convergence property of the above-described APC operation may be deteriorated due to potential fluctuation occurring in the light emitting elements 211a and 211b. There is a concern that a time for a potential output by the difference detection circuit 221 in the APC to become stable may be long.

Then, in this exemplary embodiment, a circuit described below is provided.

First, a current source 241 generates a comparison current Ibias, which is a constant current, from a power source voltage VDD. The comparison current Ibias has a constant value regardless of formation of a Y-color latent image and formation of an M-color latent image. The comparison current Ibias is given to the non-inverting (+) input terminal of the difference detection circuit 221.

Also, the light emitting element drive unit 201 is provided with a Y-color difference current generation circuit 251y and an M-color difference current generation circuit 251m. The Y-color difference current generation circuit 251y is a circuit that generates a current which is to be added to the photoelectric current Imonref and given to the inverting (−) input terminal of the difference detection circuit 221 when a Y-color latent image is formed. The M-color difference current generation circuit 251m is a circuit that generates a current which is to be added to the photoelectric current Imonref and given to the inverting (−) input terminal of the difference detection circuit 221 when an M-color latent image is formed. Since the Y-color difference current generation circuit 251y and the M-color difference current generation circuit 251m have the same circuit configuration, description will be given only on the Y-color difference current generation circuit 251y as a representative of them.

A constant current circuit 261 is provided with an operational amplifier 262, a constant voltage source 263 and a reference resistance 264. The constant voltage source 263 inputs a variable comparison voltage Vref_{y} to a non-inverting input terminal of the operational amplifier 262. The comparison resistance 264 has a resistance value Rref_{y}. One end of the comparison resistance 264 is connected to an inverting input terminal of the operational amplifier 262, and the other end of the comparison resistance 264 is connected to the ground GND. An output terminal of the operational amplifier 262 is connected to a gate of an NMOS 265, and a drain of the NMOS 265 is connected to one end of the comparison resistance 264 and the inverting input terminal of the operational amplifier 262. The constant current circuit 261 generates a reference current Iref in accordance with Iref=Vref/Rref.

A current mirror circuit 271 is configured so that a gate of a PMOS 272 is connected to gates of two PMOSs 273a and 273b, and that the respective gates are connected to a drain of the PMOS 272. The drain of the PMOS 272 is connected to the drain of the NMOS 265. The power source voltage VDD is input to sources of the respective PMOS 272, 273a and 273b. Also, the PMOS 272, 273a, 273b are formed of PMOS which are equal in W/L size to each other. Since all the gate voltages of the respective PMOS 273a and 273b are equal to each other, reference currents Iref1_{y} and Iref2_{y} are equal in current value to the reference current Iref and are output from the drain of the respective PMOS 273a and 273b, respectively.

A current source 281 generates a comparison current Ibias_{y}, which is a current equal to the comparison current Ibias, from the power source voltage VDD.

A current mirror circuit 291 is configured so that a gate of an NMOS 292 is connected to a gate of an NMOS 293 and that the respective gates are connected to a drain of the NMOS 292. The comparison current Ibias_{y} is supplied from the drain side of the NMOS 292 by the constant current circuit 281, and the sources of the NMOS 292 and 293 are connected to the ground GND. The current mirror circuit 291 outputs the comparison current Ibias_{y} from an output side thereof, using the comparison current Ibias_{y} as an input current.

A current mirror circuit 301 is configured so that a gate of a PMOS 302 is connected to a gate of a PMOS 303, and the respective gates are connected to a drain of the PMOS 302. The drain of the PMOS 302 is connected to the drain of the NMOS 293, and the drain of the PMOS 273a is connected to the drain of the NMOS 293. The reference current Iref1_{y} flows into the drain of the NMOS 293, and the output current of the current mirror circuit 291 is the comparison current Ibias_{y}. Therefore, an input current of the current mirror circuit 301 becomes “Ibias_{y}−Iref1_{y}.” The output current of the current mirror circuit 301 becomes “Ibias_{y}−Iref1_{y}”, and will be referred to as a “difference current Idiff_{y}”.

A drain of the PMOS 303 is connected to the inverting (−) input terminal of the difference detection circuit 221 via a switch SW2_{y}. When the switch SW2_{y} is closed, a current obtained by adding the difference current Idiff_{y} to the photoelectric current Imonref is supplied to the inverting (−) input terminal of the difference detection circuit 221.

Also, the drain of the PMOS 273b is connected to the inverting (−) input terminal of the difference detection circuit 221 via the switch SW2_{y} and a switch SW1_{y}. When the switches SW2_{y} and SW1_{y} are closed, a current obtained by adding the difference current Idiff_{y} and the reference current Iref2_{y} to the photoelectric current Imonref is supplied to the inverting (−) input terminal of the difference detection circuit 221.

As described above, the Y-color difference current generation circuit 251y and the M-color difference current generation circuit 251m have the same circuit configuration. and a difference current Idiffₘ of the M-color difference current generation circuit 251m corresponds to the difference current Idiff_{y} output by the Y-color difference current generation circuit 251y, and a reference current Iref2ₘ of the M-color difference current generation circuit 251m corresponds to the reference current Iref2_{y} output by the Y-color difference current generation circuit 251y.

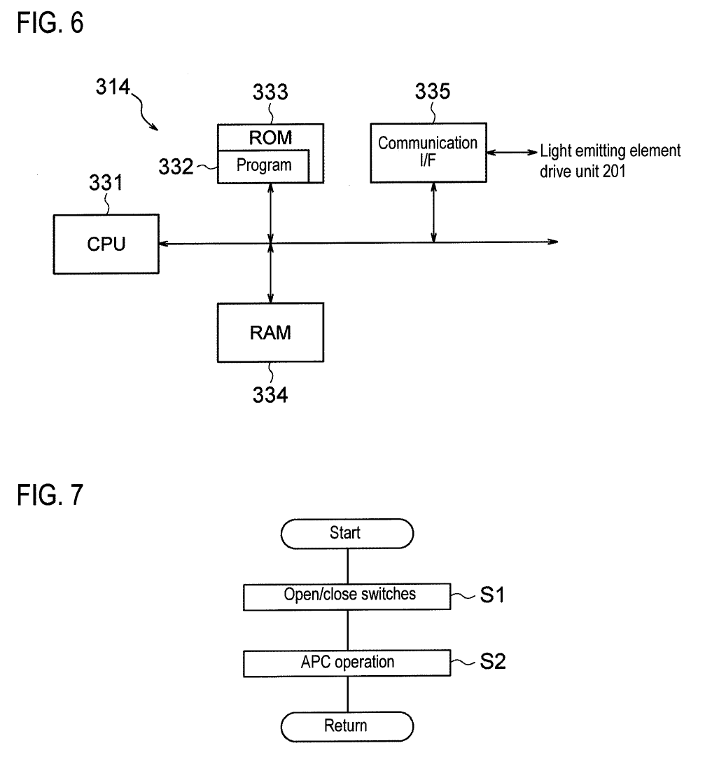

FIG. 6 is a block diagram showing electrical connections of a control section 314 that controls the YM image forming unit 2022 and the CK image forming unit 2426.

The control section 314 is, for example, a microcomputer. The control section 314 is provided with a CPU 331 for collectively controlling respective parts. A ROM 331, a RAM 334 and a communication interface (I/F) 335 are connected to the CPU 331. The ROM 333 stores various types of control programs executed by the CPU 331 and fixed data. The RAM 334 serves as a working area of the CPU 331. The communications interface 335 communicates with the light emitting element drive unit 201.

The control program 332 may be installed in the process of manufacturing the image forming apparatus 10. Instead, the control program 332 may be read later from a computer readable medium (e.g., CD-ROM, DVD-ROM or the like) storing the control program 332, and be installed in a non-volatile memory or a magnetic memory of the control section 314. Further alternatively, the control program 332 may be downloaded in the form of carrier waves from a communication line such as the Internet and be installed in the non-volatile memory or the magnetic memory of the control section 314.

Next, description will be given on an operation of the circuits shown in FIGS. 4 to 6 using as an example in which a Y-color image is formed.

FIG. 7 is a flowchart when an APC operation is carried out in the above-described circuits.

When the APC operation is to be carried out, the control section 314 opens the switch SW1_{y}, closes the switches SW2_{y}, closes the switch SW3, changes the switch SW4 so that the difference detection circuit 221 is connected to the sample-hold circuit 214a and the drive circuit 213a, and closes the switch SW5 (Step 51). Then, the APC operation described above is executed (Step S2)

As described above,

Comparison current Ibias_{y}−Reference current Iref1_{y}(=Iref_{y}=Iref2_{y})=Difference current Idiff_{y}

Therefore, the following expression can be obtained.

Comparison current Ibias_{y}=Reference current Iref1_{y}(=Iref_{y}=Iref2_{y})+Difference current Idiff_{y}

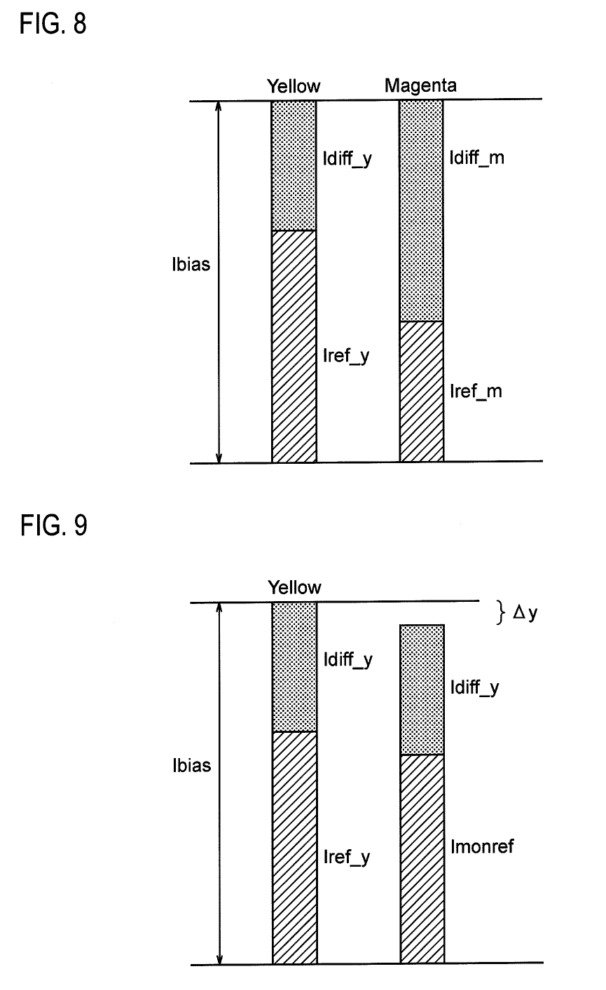

The value of the comparison current Ibias when a Y-color latent image is formed is equal to the value of the comparison current Ibias when an M-color latent image is formed, and the values of the comparison currents Ibias are shown in FIG. 8. As described above, the light-emitting power of the light emitting elements 211a and 211b very from the case where the Y-color latent image is formed to the case where the M-color latent image is formed. Therefore, the value of the reference current Iref1_{y} is different from that of the reference current Iref1ₘ. The values of the difference current Idiff_{y} and the difference current Idiffₙ, are also accordingly different from each other.

There is a difference equivalent to Δy between the reference current Iref1_{y} and the photoelectric current Imonref. Therefore, there is a difference equivalent to Δy between (i) a current value obtained by adding the difference current Idiff_{y} to the photoelectric current Imonref and (ii) the comparison current Ibias_{y} as shown in FIG. 9. Therefore, when the APC operation is carried out, the feedback control is carried out in the difference detection circuit 221 so as to cancel this difference Δy.

Thus, in comparison with the case where the reference current Iref1_{y} when a Y-color image is formed or the reference current Iref1ₘ when an M-color image is formed is supplied to the non-inverting (+) input terminal of the difference detection circuit 221 and is directly compared with the photoelectric current Imonref, the current supplied to the non-inverting (+) input terminal of the difference detection circuit 221 less varies from the case where a Y-color latent image is formed to the case where an M-color latent image.

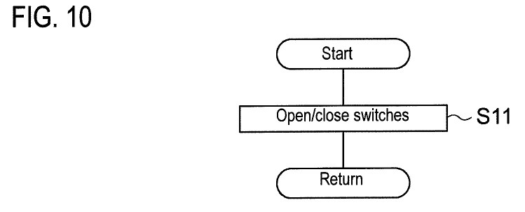

FIG. 10 is a flowchart when the APC operation is not carried out.

When the APC operation is not carried out, the control section 314 carries out such a switch opening and closing operation so as to close the switch SW1_{y}, close the switch SW2_{y} and open the switch SW3 (Step S11).

Therefore, since the current obtained by adding the difference current Idiff_{y} to the reference current Iref1_{y} will be supplied to the non-inverting (+) input terminal of the difference detection circuit 221, the current value becomes the comparison current Ibias that does not vary depending on either the case where a Y-color latent image is formed or the case where an M-color latent image is formed.

What is claimed is:

1. An exposure device comprising:
a light emitting element;
a reference current generating unit that generates a reference current which gives a target value of a light amount of the light emitting element, for each image of respective colors formed by exposure using the light emitting element;
a photoelectric current generating unit that generates a photoelectric current in response to the light amount of the light emitting element;
a driving unit that drives the light emitting element;
a first controller that controls the driving unit so that the photoelectric current becomes equal to the reference current;
a drive voltage holding unit that holds a drive voltage which is given to the driving unit by the first controller;
a second controller that controls the driving unit based on the drive voltage held by the drive voltage holding unit to carry out the exposure by the light emission of the light emitting element;
a comparison current generating unit that generates a certain comparison current; and
a difference current generating unit that generates a difference current, of each color, having a value corresponding to a difference between the reference current of each color and the comparison current, wherein
the first controller compares a value obtained by adding the difference current of each color to the photoelectric current with the comparison current to control the driving unit so that the photoelectric current becomes equal to the reference current.

2. The exposure device according to claim 1, wherein the first controller compares a value obtained by adding the difference current of each color to the reference current of each color with the comparison current when the first controller does not control the driving unit so that the photoelectric current becomes equal to the reference current.

3. An image forming apparatus comprising:
a photosensitive body;
an exposure device that forms a latent image on the photosensitive body; and
a developing device that develops the latent image, wherein
the exposure device includes
a light emitting element,
a reference current generating unit that generates a reference current which gives a target value of a light amount of the light emitting element, for each image of respective colors formed by exposure using the light emitting element,
a photoelectric current generating unit that generates a photoelectric current in response to the light amount of the light emitting element,
a driving unit that drives the light emitting element,
a first controller that controls the driving unit so that the photoelectric current becomes equal to the reference current,
a drive voltage holding unit that holds a drive voltage which is given to the driving unit by the first controller,
a second controller that controls the driving unit based on the drive voltage held by the drive voltage holding unit to carry out the exposure by the light emission of the light emitting element,
a comparison current generating unit that generates a certain comparison current, and
a difference current generating unit that generates a difference current, of each color, having a value corresponding to a difference between the reference current of each color and the comparison current, and
the first controller compares a value obtained by adding the difference current of each color to the photoelectric current with the comparison current to control the driving unit so that the photoelectric current becomes equal to the reference current.

4. A computer-readable medium storing a program that cause a computer to execute an exposure control process, wherein
an exposure device includes
a light emitting element,
a reference current generating unit that generates a reference current which gives a target value of a light amount of the light emitting element, for each image of respective colors formed by exposure using the light emitting element,
a photoelectric current generating unit that generates a photoelectric current in response to the light amount of the light emitting element,
a driving unit that drives the light emitting element,
a first controller that controls the driving unit so that the photoelectric current becomes equal to the reference current,
a drive voltage holding unit that holds a drive voltage which is given to the driving unit by the first controller,
a second controller that controls the driving unit based on the drive voltage held by the drive voltage holding unit to carry out the exposure by the light emission of the light emitting element,
a comparison current generating unit that generates a certain comparison current, and
a difference current generating unit that generates a difference current, of each color, having a value corresponding to a difference between the reference current of each color and the comparison current,
the exposure control process comprising:
controlling the exposure device so as to cause the driving unit to compare a value obtained by adding the difference current of each color to the photoelectric current with the comparison current to control the driving unit so that the photoelectric current becomes the reference current.
